(19) United States
(12) Patent Application Publication
(10) Pub. No.: US 2022/0330513 A1
(43) Pub. Date: Oct. 20, 2022

(54) ROTARY SWEEP FOR DOMESTIC FARM ANIMALS, A MILKING FACILITY INCLUDING SUCH A GATE, AND METHOD OF TRAINING DOMESTIC FARM ANIMALS USING SUCH SWEEP

(71) Applicant: STURDY BUILT MANUFACTURING, LLC, Denver, PA (US)

(72) Inventor: Evan Weaver NEWSWANGER, Denver, PA (US)

(21) Appl. No.: 17/235,420

(22) Filed: Apr. 20, 2021

(51) Int. Cl. A01K 1/00

(52) U.S. Cl. CPC A01K 1/0029; A01K 1/126

(57) ABSTRACT

A system for urging a farm animal including a connecting lane between a holding pen and a milking parlor. The connecting lane includes a sweep for urging the farm animal along the connecting lane. The sweep includes a movable body configured to move along the connecting lane and a sweep arm connected with the movable body. The sweep arm being configured to raise and/or lower with respect to the movable body.

### BACKGROUND

One or more embodiments of the present disclosure relate generally to a sweep for domestic animals and, more particularly, to such a sweep for urging an animal along a lane between a holding pen and a rotary parlor. The lane provides a path for an animal to traverse between a holding pen, which may retain one or more animals, and a rotary parlor. At the rotary parlor, the animal enters an individual stall for further handling, e.g., milking in the case of cows.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a top view of a portion of a milking facility including a holding pen, a rotary milker, and a lane connecting therebetween, in accordance with some embodiments.

FIG. 2 is another top view of the portion of the milking facility of FIG. 1, in accordance with some embodiments.

FIG. 3 is a perspective view of a rotary sweep usable in the connecting lane, in accordance with some embodiments.

FIG. 4 is a side view of the sweep, in accordance with some embodiments.

FIG. 5 is a front view of the sweep, in accordance with some embodiments.

FIG. 6 is a top view of the sweep, in accordance with some embodiments.

FIG. 7 is a rear view of the sweep, in accordance with some embodiments.

FIG. 8 is an enlarged partial perspective view of the sweep, in accordance with some embodiments.

FIG. 9 is a detail perspective view of the sweep, in accordance with some embodiments.

FIG. 10 is another perspective view of the sweep, in accordance with some embodiments.

FIG. 11 is a reverse perspective view of the sweep, in accordance with some embodiments.

FIGS. 12A-D are side views of operation of sweep 118 in urging cows along connecting lane 106, in accordance with some embodiments.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

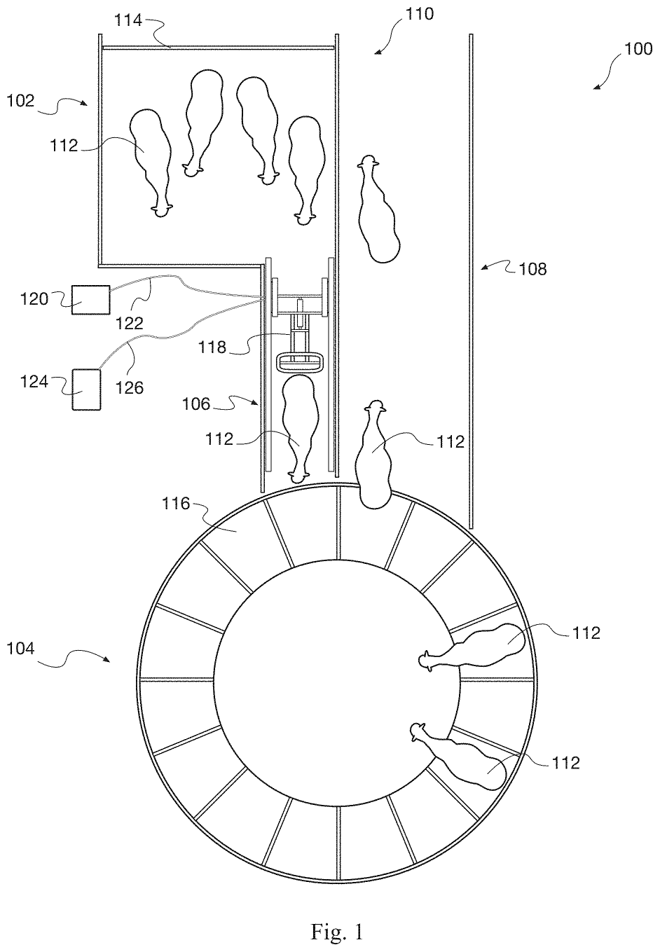

FIG. 1 is a top view of a portion of a milking facility 100 including a holding pen 102, a rotary milker 104, and a lane 106 connecting therebetween, in accordance with some embodiments. Milking facility 100 further includes an exit lane 108 for connecting between the rotary milker 104 and an exit 110.

Several cows 112 are in holding pen 102 prior to entering connecting lane 106. A cow 112 is in lane 106 (also referred to as a connecting lane) prior to entering rotary milker 104. Several cows 112 are in the rotary milker 104 and another cow 112 is exiting the rotary milker and entering exit lane 108.

Holding Pen

Holding pen 102 receives multiple cows 112 prior to milking via rotary milker 104. Holding pen 102 also includes a crowd gate 114 at a rear end of the pen in order to keep the cows moving toward connecting lane 106. Crowd gate 114 is positioned opposite the end of holding pen 102 from the opening to connecting lane 106. Crowd gate 114 is movable toward connecting lane 106. In operation, crowd gate 114 automatically moves to sweep cows 112 from one end of holding pen 102 to the other end and forces them to enter into connecting lane 106. Holding pen 102 comprises barriers, e.g., pipes, walls, or the like, forming the boundaries to prevent exit of cows 112.

In some embodiments, holding pen 102 does not include crowd gate 114. In some embodiments, crowd gate 114 is hinged at one end and sweeps an arc of holding pen 102 to move cows 112 to connecting lane 106.

Rotary Milker

Rotary milker 104 is a circular-shaped platform on which cows 112 are transported during milking. Rotary milker 104 rotates in a counter-clockwise direction transporting cows 112 from an entry point at connecting lane 106 to an exit point at exit lane 108.

Rotary milker 104 includes a plurality of stalls 116 spaced around a periphery portion of the platform. In at least some embodiments, stalls 116 comprise barriers, e.g., pipes, walls, or the like, separating cows 112 from each other while on the platform. In at least some embodiments, stalls 116 comprise barriers forming opposing side walls of the stalls 116 extending in a radial manner from the center of the platform. Cows 112 enter into an individual stall 116 on rotary milker 104 from connecting lane 106. In stall 116, cow 112 is subjected to milking operations including cleaning, milking, and the like. During rotation of stall 116 on rotary milker 104, cow 112 stands and, in at least some embodiments, is fed. After completion of milking operations on cow 112, the cow exits stall 116 and proceeds to move along exit lane 108 to exit 110 from milking facility 100.

In some embodiments, there are 24 stalls 116 in rotary milker 104. In at least some embodiments, the stalls 116 are evenly spaced around the periphery of rotary milker 104. In at least some embodiments, the stalls 116 are unevenly spaced around the periphery of rotary milker 104. In some embodiments, there are greater or fewer number of stalls 116 in rotary milker 104.

Connecting Lane

Connecting lane 106 connects holding pen 102 and rotary milker 104 providing a path for a single cow 112 to traverse from one location to the other and thereby enter an individual stall 116. Connecting lane 106 ranges in width from 3 feet to 10 feet and has a length ranging from 8 feet to 20 feet. In at least some embodiments, connecting lane 106 tapers from a first width at the connection with holding pen 102 to a second, narrower width at the connection with rotary milker 104. In such tapering embodiments, in some instances connecting lane 106 tapers from a first width of 10 feet to a second width of 3 feet. In some embodiments, connecting lane 106 is wider or narrower in width. In some embodiments, connecting lane 106 is longer or shorter in length. Connecting lane 106 comprises barriers, e.g., pipes, walls, or the like, forming the side walls connecting holding pen 102 and milker 104. In all embodiments, a single cow 112 is moved from connecting lane 106 to rotary milker 104.

Connecting lane 106 includes a rotary sweep 118 (also referred to herein as a sweep or rotary speed sweep) in, and suspended above, the lane. Sweep 118 is configured to move forward and backward along connecting lane 106. Sweep 118 is further configured having a portion which raises and lowers to correspondingly pass over and contact a rear of a cow 112 to thereby urge the cow along the connecting lane 106 and into a stall 116 of rotary milker 104.

Sweep 118 comprises one or more motors to move the sweep along connecting lane 106 and to raise and lower the portion for contact with the cow. In at least some embodiments, the one or more motors are hydraulic or pneumatic motors. Because cows 112 are sensitive to electricity, hydraulic or pneumatic motors are used in order to avoid the sensitivity and the impact such electricity may have on getting the cows to use the rotary milker 104 or milk or milk production. In at least some embodiments, hydraulic motors are fluid-powered motors. In at least some embodiments, the fluid is a liquid. In at least some embodiments, pneumatic motors are gas-powered motors. In at least some embodiments, the gas is air. In at least some embodiments, the motors are linear actuators.

A power supply 120 provides fluid or gas under pressure via lines 122 to sweep 118 for motive operation of the sweep. In at least some embodiments, power supply 120 is a hydraulic or pneumatic supply. In at least some embodiments, the fluid is a liquid and/or the gas is air. A worker controls operation of sweep 118 via a controller 124 connected via control line 126 to sweep 118. Controller 124 comprises controls for manipulation by the worker to cause sweep 118 to travel forward and backward along connecting lane 116 and to raise and/or lower the portion of the sweep for contacting the cow. Controller 124 controls the pressure supplied via lines 122 to portions of sweep 118. In at least some embodiments, controller 124 includes buttons electrically connected to a power supply for controlling the flow of fluid or gas to/from sweep 118. In at least some embodiments, controller 124 is wirelessly connected to a power supply for controlling the flow of fluid or gas to/from sweep 118.

Sweep 118 is controlled by a worker during the operation of urging the cow into the stall 116.

In at least some embodiments, sweep 118 is arranged in a center of the width of connecting lane 106. In at least some embodiments, sweep 118 is movable along the entire length of connecting lane 106. In at least some embodiments, sweep 118 is movable along the last 10 feet of connecting lane 106 prior to the connection of connecting lane 106 with rotary milker 104. In at least some embodiments, the portion of sweep 118 contacting cow 112 extends beyond the end of connecting lane 106.

In operation, cows 112 move along connecting lane 106 from holding pen 102 to enter an individual stall 116 on rotary milker 104 for milking operations. At times, a cow 112 requires urging to move on to rotary milker 104, e.g., a cow which has never experienced the rotary milker, a cow which has yet to become accustomed to the rotary milker, or a cow which has become reticent or stubborn at boarding the rotary milker for some reason. In other approaches, a worker urges the cow using noise and/or hands-on force against the cow to cause the cow to continue onto rotary milker 104. These approaches may be ineffective and/or dangerous to the worker being in close proximity depending on the response of the cow. Additionally, depending on the noise and/or force used, there may be a negative connection made in the mind of the cow with the location or action being requested which could result in negative feedback to the action being requested, i.e., the cow might be less inclined to enter rotary milker 104 than without the urging. In still other approaches, shock (electrified prods) sticks are used to urge cow 112 along connecting lane 106 having detrimental impact to the cow.

In contrast, in accordance with an embodiment of the present disclosure, a worker controls sweep 118 to sweep cow 112 toward stall 116. The worker need not be in close proximity of cow 112 during pushing of the cow and need not directly contact the cow. In this manner, a firm urging of cow 112 is performed without use of direct/indirect electricity. After a few urgings, cow 112 becomes accustomed/re-accustomed to boarding rotary milker 104 and sweep 118 need not be used for the particular cow. At this time, sweep 118 is stored in a raised position such that cow 112 is able to pass under without interaction and sweep 118 remains available for future use.

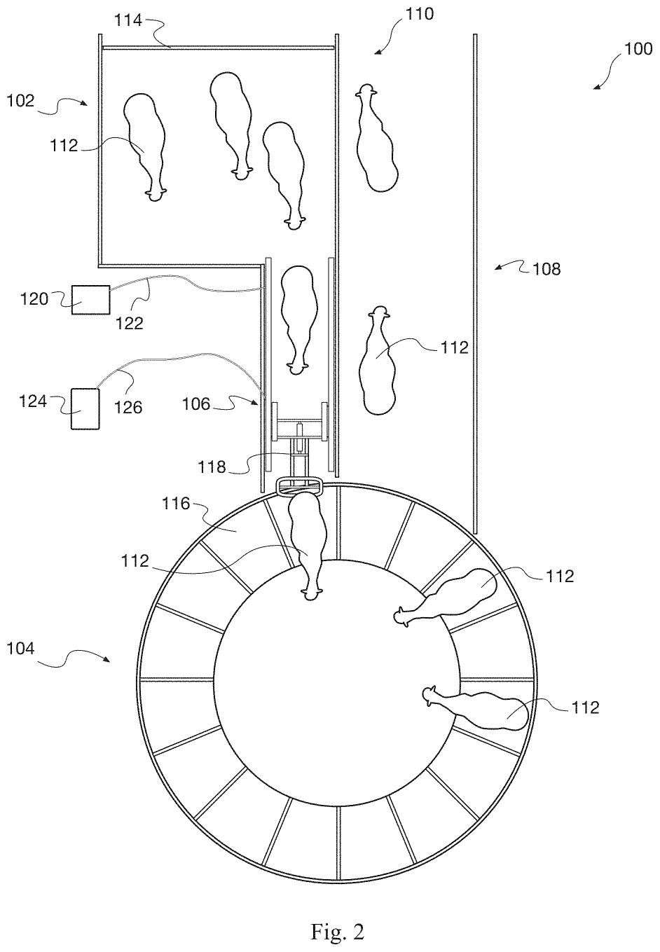

FIG. 2 is another top view of the portion of the milking facility of FIG. 1, in accordance with some embodiments.

In FIG. 2, sweep 118 has moved along connecting lane 116 toward rotary milker 104. With sweep 118 lowered, the front portion of the sweep has contacted the rear of cow 112 and urged the cow into stall 116 of rotary milker 104. The front portion of sweep 118 extends beyond the end of connecting lane 106. During the process another cow 112 has moved from holding pen 102 and into the portion of connecting lane 106 previously occupied by the first cow 112. After the first cow is in stall 116, sweep 118 is able to be raised and moved back over the second cow for further use, if needed.

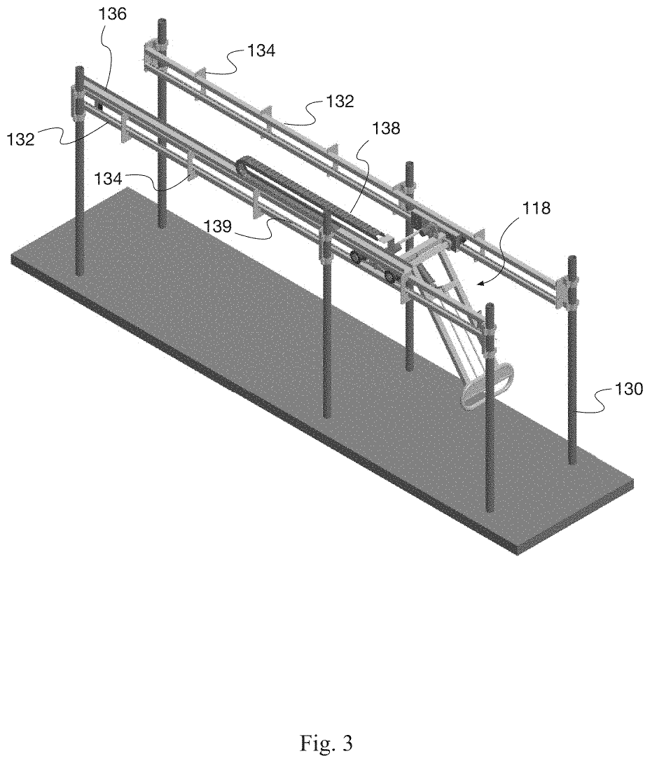

FIG. 3 is a perspective view of a sweep usable in the connecting lane, in accordance with some embodiments.

For simplicity, the barriers of connecting lane 106 are omitted from FIG. 3. Connecting lane 106 includes two sets of three linearly aligned support posts 130 on opposite sides of the connecting lane. Each of the support posts 130 extends to a height greater than the height of a cow 112. More particularly, each of the support posts 130 extends to a height such that the lowest portion of sweep 118 is above the height of a cow 112 when sweep arm 142 is in a horizontal position.

In at least some embodiments, support posts 130 are evenly spaced apart between the first and last post. In at least some embodiments, there are greater or fewer number of support posts 130 on each side of connecting lane 106. In at least some embodiments, each of the support posts 130 extends to the same height. In at least some embodiments, support posts 130 are separate elements from the barriers of connecting lane 106. In at least some embodiments, support posts 130 are an integral part of the barriers of connecting lane 106. In at least some embodiments, support posts 130 are made of metal, e.g., galvanized or stainless steel.

A stacked pair of rails 132 extend along each side of connecting lane 106 supported by support posts 130. Rails 132 are rectangular in cross-section and extend linearly from a first support post 130 to a last support post. Rails 132 are stacked in a vertical arrangement.

Brackets 134 connect rails 132 to support posts 130, e.g., via bolts, welding, or the like. Brackets 134 are sideways U-shaped and maintain vertical separation between pairs of rails 132.

In at least some embodiments, rails 132 are longer or shorter in length. In at least some embodiments, rails 132 extend beyond the end of connecting lane 106. In at least some embodiments, rails 132 end prior to the end of connecting lane 106. In at least some embodiments, rails 132 are stacked in a horizontal direction. In at least some embodiments, rails 132 are metal, e.g., galvanized or stainless steel. In at least some embodiments, rails 132 are separated by 5 and ⅛ inches in a vertical direction. In at least some embodiments, the separation between stacked rails 132 is larger or smaller. In at least some embodiments, the separation is sufficient to accommodate rollers 147 to pass between the rails 132.

In at least some embodiments, brackets 134 are other than U-shaped. In at least some embodiments, brackets 134 are L-shaped. In at least some embodiments, brackets 134 are positioned such that the open end faces toward the interior of connecting lane 106. In at least some embodiments, brackets 134 are metal.

A tray 136 is mounted above the upper rail 132 on one side of, and extending along, connecting lane 106. Tray 136 is mounted in connection with an upper portion of bracket 134 on one side of connecting lane 106. Tray 136 extends along at least a portion of one side of connecting lane 106.

In at least some embodiments, more than one tray 136 is used in connection with connecting lane 106. In at least some embodiments, a tray 136 is mounted above each pair of rails 132 on opposite sides of connecting lane 106. In at least some embodiments, tray 136 is shorter in length than rails 132. In at least some embodiments, tray 136 is wider than the cross-section of rails 132.

A flexible tray 138 comprises a plurality of individual links connected together and able to pivot with respect to adjacent links. Flexible tray 138 fits within tray 136 and is attached to tray 136 at one end. The other end of flexible tray 138 is connected with sweep 118. As sweep 118 moves from one end of connecting lane 106 to the other end, flexible tray 138 rolls and unrolls to overlap more or less of its length along connecting lane 106. At a position at which the two ends of flexible tray 138 are closest together, the maximum amount of overlap occurs with flexible tray, i.e., the flexible tray is folded in half. At a position at which the two ends of flexible tray 138 are farthest apart, the minimum amount of overlap occurs with flexible tray 138. Flexible tray 138 is U-shaped in cross-section and defines an open volume within which lines 122 are arranged. In at least some embodiments, lines 122 are hydraulic or pneumatic lines. Using flexible tray 138 enables a minimization of stress on lines 122 due to the lack of pull being applied along the lines during movement of sweep 118. Additionally, control line 126 is able to be arranged within flexible tray 138.

In at least some embodiments, flexible tray 138 is made of metal, plastic, or the like. In at least some embodiments, flexible tray 138 is a same length as tray 136. In at least some embodiments, there is at least one flexible tray 138 on each side of connecting lane 106. In at least some embodiments, control line 126 is arranged within a separate flexible tray 138 on the opposite side of lines 122. In at least some embodiments, flexible tray 138 is flexible in one direction and rigid in the transverse direction.

A chain 139 is on top of the lower rail of the stacked pair of rails 132. Chain 139 extends along the length of rails 132 and is aligned with the rails. Chain 139 is attached at each end to a bracket 134. A chain 139 is on top of each lower rail on opposite sides of connecting lane 106.

In at least some embodiments, chain 139 is attached to bracket 134 at at least one end using an adjustable mechanism, e.g., a threaded bolt or the like, in order to adjust the tension applied to the chain. In at least some embodiments, chain 139 is on top of only one lower rail on one side of connecting lane 106.

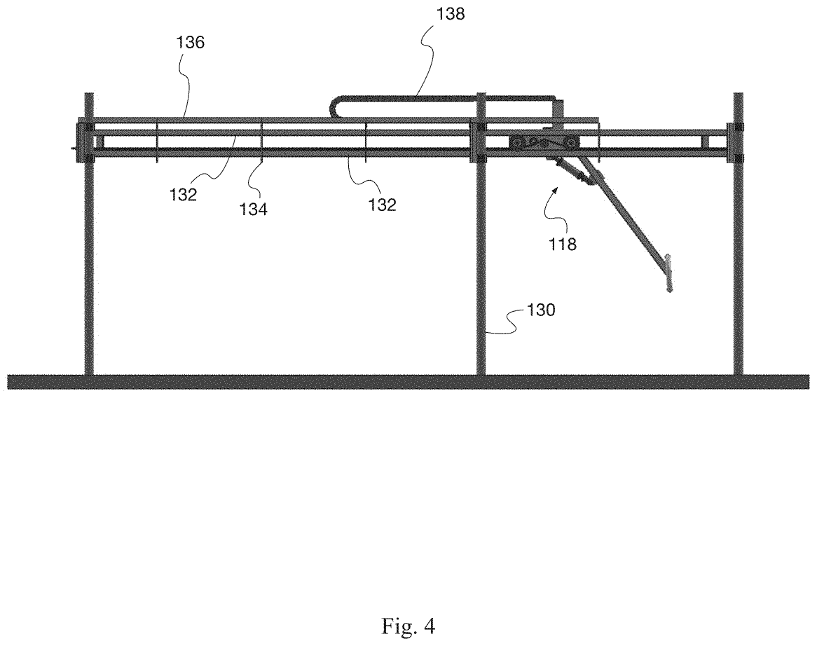

FIG. 4 is a side view of the sweep usable in connecting lane 106, in accordance with some embodiments. The leading portion of sweep 118 is in an extended or lowered position for pushing or urging a cow 112 along connecting lane 106.

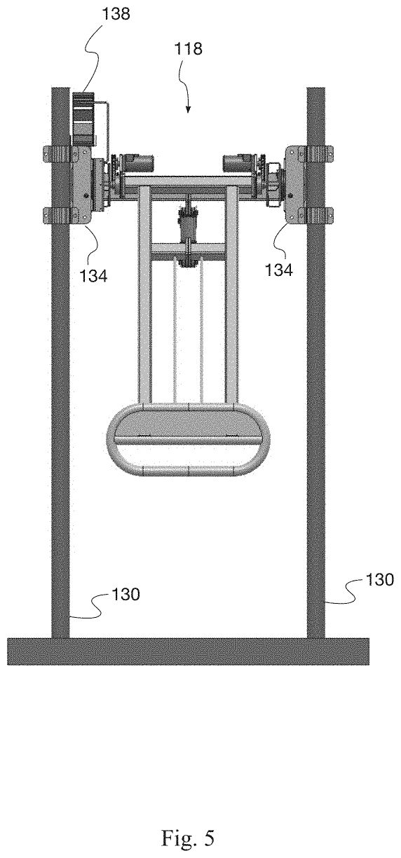

FIG. 5 is a front view of the sweep usable in connecting lane 106, in accordance with some embodiments. The leading portion of sweep 118 is in an extended or lowered position for pushing or urging a cow 112 along connecting lane 106. FIG. 5 is a view toward holding pen 102. The leading portion of sweep 118 is configured to prevent injury to an animal when applying pressure to animals of differing size and/or height. In at least some embodiments, the leading portion of sweep 118 is a solid panel. In at least some embodiments, the leading portion of sweep 118 is a panel of circular tubing.

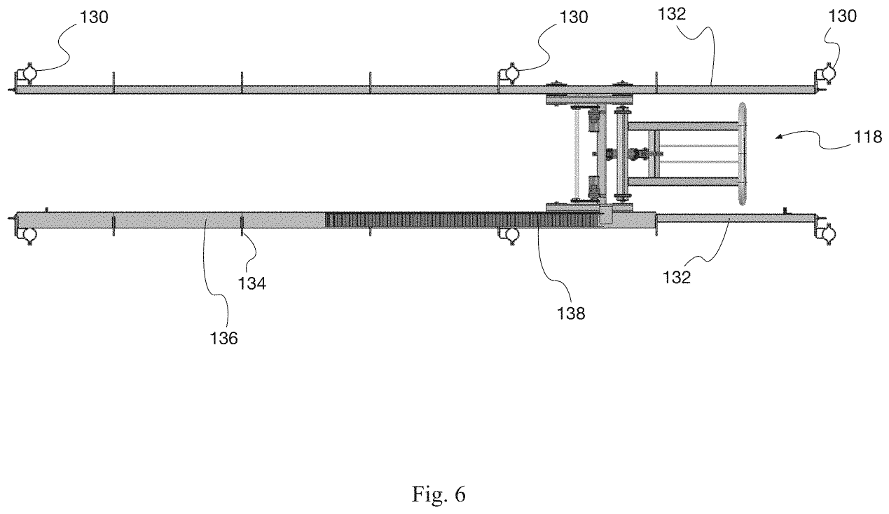

FIG. 6 is a top view of the sweep usable in connecting lane 106, in accordance with some embodiments. The leading portion of sweep 118 is in an extended or lowered position for pushing or urging a cow 112 along connecting lane 106. Sweep 118 extends across the width of connecting lane 106. Sweep 118 interacts with the stacked pair of rails 132 on each side of connecting lane 106.

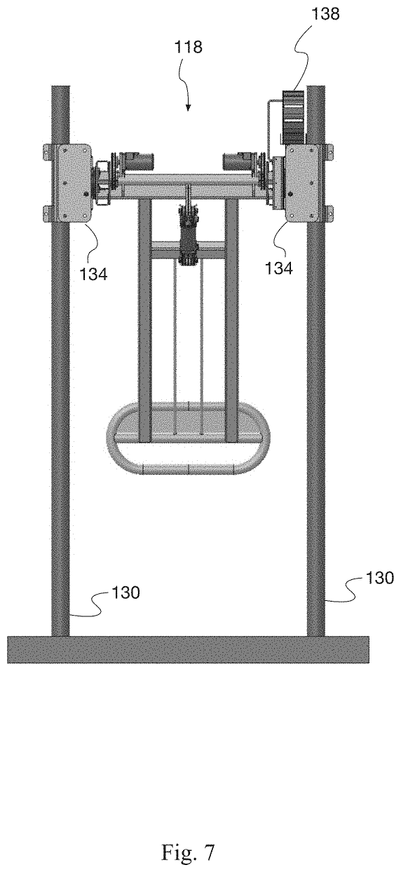

FIG. 7 is a rear view of the sweep usable in connecting lane 106, in accordance with some embodiments. FIG. 7 is a view toward rotary milker 104.

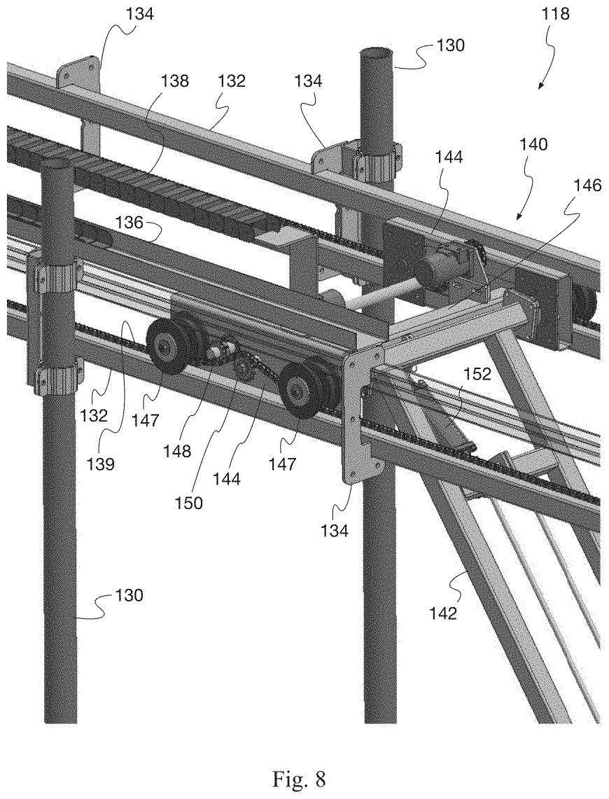

FIG. 8 is an enlarged partial perspective view of the sweep usable in connecting lane 106, in accordance with some embodiments.

Sweep 118 comprises a movable body 140 connected with a sweep arm 142. Sweep arm 142 is rotatably connected with movable body 140 at one end. In some embodiments, a shaft (not shown) extends through the end of sweep arm 142 to connect with, in a rotatable manner, movable body 140. In some embodiments, a rotary bearing plate on either side of sweep arm 142 connects the end of sweep arm with movable body 140.

Movable body 140 comprises a frame made up of two channel segments 144 on opposite sides of the body and extending along connecting lane 106. Channel segments 144 extend parallel with rails 132. The movable body frame further comprises a cross channel segment 146 connected between the channel segments 144. Cross channel segment 146 has a rectangular cross-section.

In at least some embodiments, frame comprises a greater number of channel segments and cross channel segments. In at least some embodiments, movable body frame is made of metal, e.g., galvanized or stainless steel. In at least some embodiments, channel segments 144 are 8 and ⅜ inches in height, 26 inches in length, and 2 and ⅜ inches in width. In at least some embodiments, channel segments 144 have different dimensions.

Movable body 140 further comprises rollers 147 mounted on axles extending into the movable body. Movable body 140 comprises two pairs of rollers 147 on opposite sides. Two rollers 147 are on one side of movable body 140 and two rollers are on the opposite side.

Rollers 147 are formed of a rubber, polyurethane, or polyethylene material and define a channel between two halves of the material. In at least some embodiments, rollers 147 are formed of an ultra high molecular weight polyethylene (UHMW) material. A roller sprocket (not visible) is between the two halves of roller 147 material. The defined channel fits over the width of rails 132. A portion of rollers 147 extends on the side of lower rail 132 below an upper surface of the lower rail in order to keep the sweep in place and aligned on the rails. In position on rails 132, the lower portion of roller 147 straddles the lower rail 132 and an upper portion of roller 146 straddles the upper rail 132.

The roller sprocket engages with chain 139 to assist in keeping tension on the chain and keeping the chain in position on the rail 132. The roller sprocket rotates along with the rollers 147 to enable the movable body 140 to move back and forth along the rails 132.

Movable body 140 further comprises a drive sprocket 148 attached to each end of a shaft extending through the movable body. Drive sprocket 148 engages with chain 139 and rotates to move movable body 140 back and forth along the length of the chain.

Movable body 140 further comprises an idler sprocket 150 attached to a side of channel segment 144. There is one idler sprocket 150 on each side of movable body 140. Idler sprocket 150 rotates and operates to maintain tension on chain 139.

Chain 139 extends along rail 132. Chain 139 passes below a first roller sprocket, below drive sprocket 148, above idler sprocket 150, and then below a second roller sprocket. Chain 139 engages with the teeth of each of the first and second roller sprockets, drive sprocket 148, and idler sprocket 150.

A piston 152 connects sweep arm 142 and movable body 140. Under gas or fluid control, piston 152 causes sweep arm 142 to raise or lower with respect to movable body 140. One end of piston 152 is connected to cross channel segment 146. Sweep 152 is connected with, and powered by, supply 120 via line 122. In at least some embodiments, piston 152 is a linear actuator.

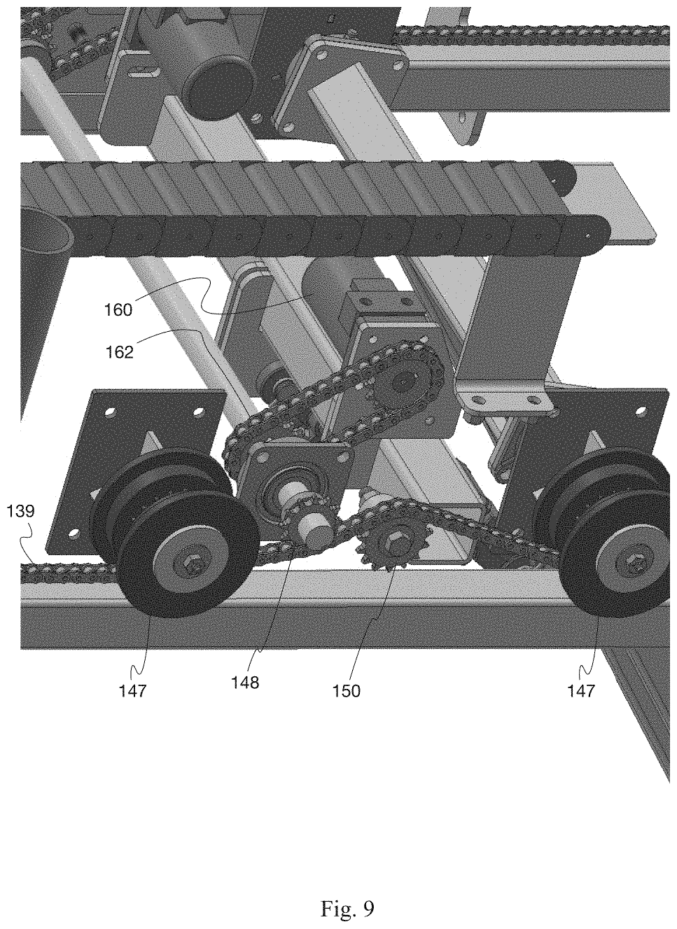

FIG. 9 is a detail perspective view of the sweep, in accordance with some embodiments.

For clarity, the near channel segment 144 in FIG. 9 has been removed to enable better visibility. Movable body 140 further comprises a motor 160 connected to cross channel segment 146. Another motor 160 is on the opposite side of cross channel segment 146 closer to the other channel segment 144. Motor 160 is connected to the shaft which drives drive sprocket 148 via a chain 162. Chain 162 engages a sprocket on motor 160 and a sprocket on the shaft. Rotation and counter-rotation of motor 160 causes drive sprocket 148 to move movable body 140 backward and forward along chain 139 and thereby along connecting lane 106.

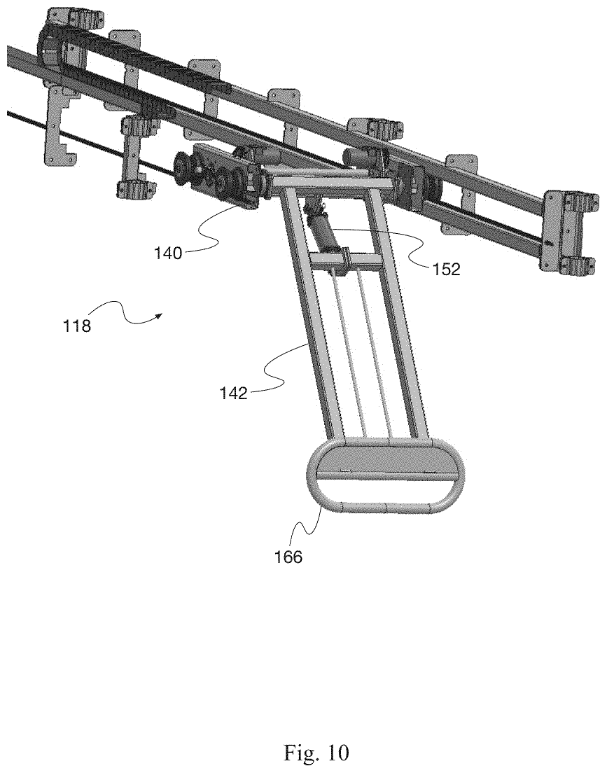

FIG. 10 is another perspective view of the sweep, in accordance with some embodiments. For clarity, the near pair of stacked rails 132 have been removed to enable better visibility. As depicted, piston 152 connects movable body 140 with sweep arm 142. Piston 152 is configured to move sweep arm 142 relative to movable body 140. In particular sweep arm 142 swings between a horizontal level co-planar with the extent of movable body 140 and forming an angle with respect to the movable body. In at least some embodiments, sweep arm 142 forms an angle ranging from zero to 45 degrees with respect to movable body 140. In at least some embodiments, sweep arm 142 forms an angle ranging from zero to 60 degrees with respect to movable body 140.

In operation, after sweep arm 142 is used to urge a cow along connecting lane 106, the sweep arm 142 is raised using piston 152 to a horizontal or near-horizontal position and, in conjunction with movable body 140, is moved in reverse along connecting lane 106 toward holding pen 102. Motors 160 are rotated in reverse causing the drive sprocket 148, engaged with chain 139, to move the movable body 140 back along the chain. In this manner, sweep 118 is able to be moved up and over a next cow within connecting lane 106. If the next cow in connecting lane 106 requires urging, piston 152 lowers sweep arm 142 to an angle with respect to movable body 140 and the motors 160 are rotated to cause the drive sprocket 148 to move the sweep 118 toward the rear of the cow.

The end of sweep arm 142 distal from movable body 140 includes a sweep plate 166 for contact with the rear of the cow. Sweep plate 166 is a rounded rectangular tubular frame for contact with the cow. In at least some embodiments, sweep plate 166 is a square-shaped frame. In at least some embodiments, sweep plate 166 is another shape for contact with the rear of the cow. Sweep plate 166 forms an angle of 45 degrees with respect to sweep arm 142. In at least some embodiments, sweep plate 166 forms an angle ranging from zero to 60 degrees with respect to sweep arm 142. An angle between sweep plate 166 and sweep arm 142 is desired in order to present a flat pushing surface to the rear of the cow to minimize the chance of injury. In at least some embodiments, sweep plate 166 is configured to rotate with respect to sweep arm 142, e.g., sweep plate 166 is rotationally hinged to sweep arm 142. In at least some embodiments, another piston connects sweep plate 166 with sweep arm 142 enabling adjustment of the angle between the sweep plate and the sweep arm. In at least some embodiments, the piston between the sweep plate 166 and sweep arm 142 is connected with, and powered by, supply 120 via line 122. In at least some embodiments, the piston is a linear actuator.

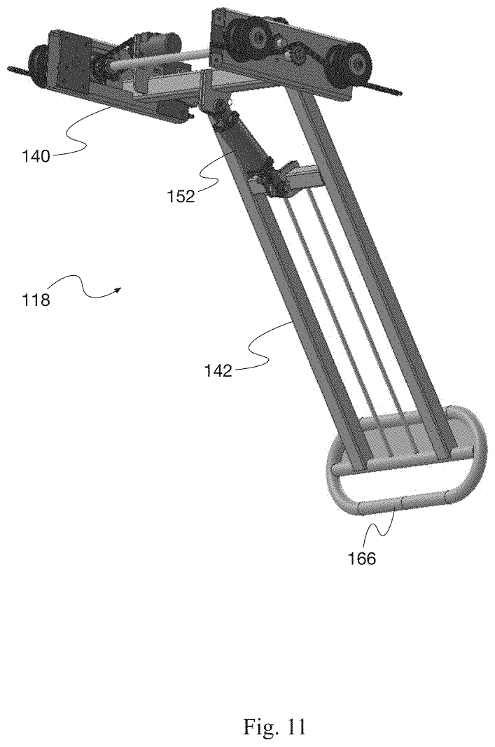

FIG. 11 is a reverse perspective view of the sweep, in accordance with some embodiments. For clarity, both pairs of stacked rails 132 have been removed to enable better visibility. Sweep plate 166 is 14 inches tall and 31 inches wide. In at least some embodiments, sweep plate 166 is taller or shorter. In at least some embodiments, sweep plate 166 is wider or narrower.

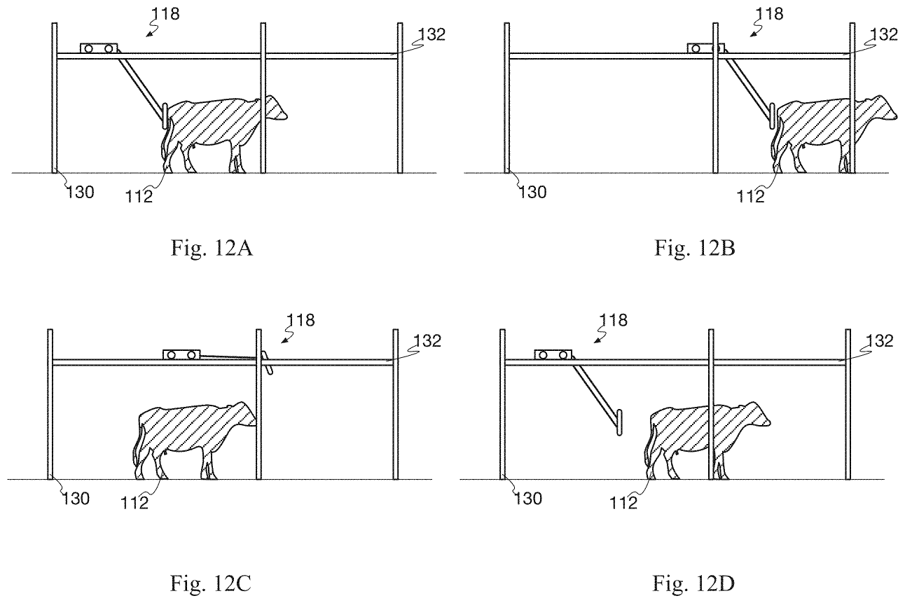

FIGS. 12A-D are side views of operation of sweep 118 in urging cows along connecting lane 106, in accordance with some embodiments. FIG. 12A is a side view of a cow 112 being urged along connecting lane 106 toward milker 104 by sweep 118. Sweep plate 166 is in contact with the rear of the cow to urge the cow toward milker 104.

FIG. 12B is a side view of the cow 112 at a later time after being urged along connecting lane 106 to milker 104. After the cow 112 is in place in stall 116, sweep 118 raises sweep arm 142, and sweep plate 166, to a near horizontal position and reverses direction along connecting lane 106.

FIG. 12C is a side view of sweep 118 moving backward along connecting lane 106 and over another cow 112 in the connecting lane. After sweep 118 passes sufficiently beyond the rear of cow 112 such that sweep arm 142 can be lowered behind the cow, the sweep arm is lowered to an angle with respect to movable body 140 of sweep 118.

FIG. 12D is a side view of sweep 118 with sweep arm 142 lowered to an angle with respect to movable body 140 of sweep 118 behind the rear of cow 112. Sweep 118 is able to be moved along connecting lane 106 to urge the cow along the connecting lane toward milker 104. If the cow 112 does not require the use of sweep 118, sweep arm 142 need not be lowered and can remain in a horizontal position.

In at least one aspect, a system for urging a farm animal comprises a connecting lane between a holding pen and a milking parlor, the connecting lane comprising a sweep for urging the farm animal along the connecting lane, the sweep comprising: a movable body configured to move along the connecting lane; and a sweep arm connected with the movable body, the sweep arm configured to raise and/or lower with respect to the movable body.

In at least some embodiments, the connecting lane is wide enough to allow only a single farm animal to traverse the connecting lane at a time.

In at least some embodiments, the connecting lane width ranges from 3 to 10 feet.

In at least some embodiments, the movable body comprises: at least one motor; and at least one drive sprocket connected to the at least one motor.

In at least some embodiments, the motor is a hydraulic or pneumatic motor.

In at least some embodiments, the movable body further comprises a drive shaft connecting the at least one motor to the at least one drive sprocket.

In at least some embodiments, the sweep arm is connected at one end to the movable body.

In at least some embodiments, the end of the sweep arm distal from the movable body has a sweep face.

In at least some embodiments, the sweep face is at an angle to the sweep arm.

In at least some embodiments, the sweep face is at a 45° angle to the sweep arm.

In at least some embodiments, the sweep further comprises a piston connecting the movable body to the sweep arm.

In at least some embodiments, the piston is configured to extend and/or retract causing the sweep arm to raise and/or lower with respect to the movable body.

In at least some embodiments, wherein the connecting lane further comprises: at least two rails extending along opposite sides of the connecting lane; and the movable body further comprises at least two rollers on opposite sides of the movable body, the rollers engaged with at least one of the at least two rails.

In at least some embodiments, the connecting lane further comprises: at least two support posts configured to support the at least two rails above the connecting lane.

In at least some embodiments, the connecting lane further comprises at least one chain extending along at least one rail of the at least two rails.

In at least some embodiments, the rollers comprise a roller sprocket engaged with the at least one chain.

In at least some embodiments, the drive sprocket engages the at least one chain.

In at least some embodiments, the movable body further comprises an idler sprocket engaged with the at least one chain.

In at least some embodiments, the connecting lane further comprises a flexible tray extending along at least one rail of the at least two rails and configured to have one end connected to the movable body.

In at least some embodiments, the flexible tray is configured to have the other end connected to the at least one rail.

In at least some embodiments, the system further comprising one or more power lines extending along the flexible tray, wherein at least one power line of the one or more power lines is a hydraulic line.

In at least some embodiments, the system further comprising one or more control lines extending along the flexible tray, at least one control line of the one or more control lines controls the motive force supplied to the movable body.

In another aspect, a method of operating a sweep for urging a farm animal along a connecting lane, the connecting lane between a holding pen and a milking parlor, the sweep comprising a sweep arm rotatably connected with the sweep, comprises: with the sweep arm rotated at a non-horizontal angle to the sweep, using the sweep to urge a farm animal along the connecting lane toward the milking parlor; raising the sweep arm to a horizontal angle; and moving the sweep along the connecting lane toward the holding pen.

In at least some embodiments, the method further comprising: lowering the sweep arm to a non-horizontal angle to the sweep; and using the sweep to urge a farm animal along the connecting lane toward the milking parlor.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

1. A system for urging a farm animal comprising:
a connecting lane between a holding pen and a milking parlor, the connecting lane comprising a sweep for urging the farm animal along the connecting lane, the sweep comprising:
a movable body configured to move along the connecting lane; and
a sweep arm connected with the movable body, the sweep arm configured to raise and/or lower with respect to the movable body.

2. The system of claim 1, wherein the connecting lane is wide enough to allow only a single farm animal to traverse the connecting lane at a time.

3. The system of claim 2, wherein the connecting lane width ranges from 3 feet at the milking parlor to 10 feet at the holding pen.

4. The system of claim 1, wherein the movable body comprises:
at least one motor; and
at least one drive sprocket connected to the at least one motor.

5. The system of claim 4, wherein the motor is a hydraulic or pneumatic motor.

6. The system of claim 4, wherein the movable body further comprises a drive shaft connecting the at least one motor to the at least one drive sprocket.

7. The system of claim 1, wherein the sweep arm is connected at one end to the movable body.

8. The system of claim 7, wherein the end of the sweep arm distal from the movable body has a sweep face at an angle to the sweep arm.

9. The system of claim 8, wherein the sweep face is at a 45° angle to the sweep arm.

10. The system of claim 1, wherein the sweep further comprises a piston connecting the movable body to the sweep arm.

11. The system of claim 10, wherein the piston is configured to extend and/or retract causing the sweep arm to raise and/or lower with respect to the movable body.

12. The system of claim 1, wherein the connecting lane further comprises:
at least two rails extending along opposite sides of the connecting lane; and
wherein the movable body further comprises at least two rollers on opposite sides of the movable body, the rollers engaged with at least one of the at least two rails.

13. The system of claim 12, wherein the connecting lane further comprises:
at least two support posts configured to support the at least two rails above the connecting lane.

14. The system of claim 12, wherein the connecting lane further comprises at least one chain extending along at least one rail of the at least two rails.

15. The system of claim 14, wherein the drive sprocket engages the at least one chain and the rollers comprise a roller sprocket engaged with the at least one chain.

16. The system of claim 14, wherein the movable body further comprises an idler sprocket engaged with the at least one chain.

17. The system of claim 12, wherein the connecting lane further comprises a flexible tray extending along at least one rail of the at least two rails and configured to have one end connected to the movable body.

18. The system of claim 17, wherein the flexible tray is configured to have the other end connected to the at least one rail.

19. The system of claim 17, further comprising one or more power lines extending along the flexible tray, wherein at least one power line of the one or more power lines is a hydraulic or pneumatic line.

20. The system of claim 17, further comprising one or more control lines extending along the flexible tray, at least one control line of the one or more control lines controls the motive force supplied to the movable body.

21. A method of operating a sweep for urging a farm animal along a connecting lane, the connecting lane between a holding pen and a milking parlor, the sweep comprising a sweep arm rotatably connected with the sweep, the method comprising:
using the sweep to urge a farm animal along the connecting lane toward the milking parlor; and
moving the sweep along the connecting lane toward the holding pen.

22. The method of claim 22, further comprising:
lowering the sweep arm to a non-horizontal angle to the sweep; and
using the sweep to urge a farm animal along the connecting lane toward the milking parlor.

23. The method of claim 21, wherein the using the sweep to urge a farm animal along the connecting lane toward the milking parlor is performed with the sweep arm rotated at a non-horizontal angle to the sweep, and further comprising:
raising the sweep arm to a horizontal angle.
